(19) United States
(12) Patent Application Publication
(10) Pub. No.: US 2015/0048944 A1
(43) Pub. Date: Feb. 19, 2015

(54) MAGNETIC INDUCTION ALARM DEVICE

(71) Applicant: CHUNG-YANG CHEN, NEW TAIPEI CITY (TW)

(72) Inventor: CHUNG-YANG CHEN, NEW TAIPEI CITY (TW)

(21) Appl. No.: 13/966,694

(22) Filed: Aug. 14, 2013

(51) Int. Cl. G08B 13/06; E05B 45/06

(52) U.S. Cl. CPC G08B 13/06; E05B 45/06; E05B 2045/0695
USPC 340/542

(57) ABSTRACT

A magnetic induction alarm device for a locking device is provided. The locking device includes a base and a latch knob disposed on the base movably along a route including a lock section and an unlock section next to the lock section. The magnetic induction alarm device includes a magnetic element and a magnetic induction unit. The magnetic element links up with an end of the latch knob and has a magnetic region. The magnetic induction unit is disposed next to the locking device and includes a shell including a holding space, a magnetic reed switch and an alarm module disposed inside the holding space and electrically connects the magnetic reed switch. The magnetic reed switch is disposed next to the lock section and is inside the holding space, wherein the magnetic region covers the magnetic reed switch when the magnetic element is located within the lock section.

### BACKGROUND OF THE INVENTION

1. Field of the Invention

The present invention relates to a magnetic induction alarm device and more particularly, relates to an alarm device including a magnetic element disposed on a latch knob of a locking device and a magnetic induction unit disposed close to the magnetic element so as to sense whether the locking device is locked up and to remind a user.

2. Description

A magnetic induction alarm device is usually utilized to prevent burglars. When a house owner is doing housework or asleep, he/she may not notice someone is trying to unlock their door and enters the room. Therefore, they can put a magnetic induction alarm device on the door so when the door is unlocked, they can be informed by various alarms (e.g. sounds or flashlights); further, suspicious people may be deterred by the alarms.

Refer to FIG. 1, a drawing showing a conventional magnetic induction alarm device. The conventional magnetic induction alarm device PA100 includes a magnetic element PA11 disposed on a door PA21 and a magnetic induction unit PA12 disposed on a wall PA22 corresponding and close to the magnetic element PA11. When the door PA21 is closed, the magnetic element PA11 and a magnetic reed switch (not shown) of the magnetic induction unit PA12 forms a magnetic force so magnetic reeds inside (not shown) repel each other and the circuit is OFF. When someone opens the door PA21, the door PA21 movies relatively with the wall PA22 having the magnetic induction unit PA 12. Since the magnetic element PA11 is moving away, the magnetic reeds of the magnetic reed switch attract each other and the circuit is ON. At the same time, an alarm light or buzzer starts to operate to deter the burglars.

Although the conventional magnetic induction alarm device PA 100 sends alarm to warn burglars or inform the owner of the house when the door PA21 is opened, the warnings are sent after the door PA21 is opened, which cannot efficiently prevent the burglar from opening the door and burgling in.

### SUMMARY OF THE INVENTION

In prior art, the conventional magnetic induction alarm device triggers the alarm light or buzzer only when the door is opened, which cannot efficiently prevent the burglar from opening the door and burgling in.

Therefore, a magnetic induction alarm device for a locking device is provided according to embodiments of the present invention. The locking device includes a base and a latch knob; the latch knob is disposed on the base movably along a route; the route includes a lock section and an unlock section next to the lock section.

The magnetic induction alarm device includes a magnetic element and a magnetic induction unit. The magnetic element links up with an end of the latch knob and has a magnetic region. The magnetic induction unit is disposed next to the locking device and includes a shell, a magnetic reed switch and an alarm module. The shell includes a holding space. The magnetic reed switch is disposed next to the lock section and is inside the holding space, wherein the magnetic region covers the magnetic reed switch when the magnetic element is located within the lock section. The alarm module is disposed inside the holding space and electrically connects the magnetic reed switch.

When the latch knob moves along the route so the magnetic element moves from the loch section to the unlock section, the magnetic reed switch relatively moves away from the magnetic region so the magnetic reed switch generates and sends an alarm signal accordingly to the alarm module to motivate the alarm module.

According to an embodiment of the present invention, the magnetic induction alarm device further comprises a fixing member disposed on the latch knob, wherein the magnetic element is disposed on the fixing member so the magnetic element is disposed on the latch knob via the fixing member.

According to an embodiment of the present invention, the alarm module includes an alarm unit electrically connecting the magnetic reed switch for receiving an alarm signal.

According to an embodiment of the present invention, the alarm module further includes an alarm light electrically connecting the alarm unit for receiving an alarm signal and sending an alarm light signal.

According to an embodiment of the present invention, the alarm module further includes a buzzer electrically connecting the alarm unit for receiving an alarm signal and sending an alarm sound.

It is necessary to emphasized that the concept of “alarm” hereinafter is a means to remind or warn the user or anybody concerned that “do not forget to lock the locking device when it shall be locked”. Therefore, the “magnetic induction alarm device” hereinafter can be viewed as a device provided for the user or anybody concerned, so as to remind or warn him not forget to lock the locking device when it shall be locked.

According to an embodiment of the present invention, the alarm module further includes a wireless transmission unit electrically connecting the alarm unit for receiving the alarm signal and generating a wireless transmission signal, wherein the wireless transmission unit is selected from the group of wireless radio frequency transmission unit, Bluetooth transmission unit, Wi-Fi transmission unit, and WiMAX transmission unit.

According to an embodiment of the present invention, the alarm module further includes a photo sensor electrically connecting the alarm unit, the photo sensor generating a photo sensing signal to the alarm unit according to a light intensity, wherein the photo sensor includes a switch electrically connecting the photo sensor so the photo sensor switches to an automatic photo sensing mode or a manual photo sensing mode. In the automatic photo sensing mode, the photo sensor determines whether to generate and send the photo sensing signal to the alarm unit according to the light intensity; in the manual photo sensing mode, a user determines whether to turn on the alarm module or not.

In conclusion, the magnetic induction alarm device provided according to embodiments of the present invention includes the magnetic element and the magnetic induction unit. The magnetic element is fixed on the latch knob via the fixing member; the magnetic induction unit is disposed next to the magnetic element. When the magnetic unit moves along the route to the unlock section, the magnetic induction unit is triggered so the alarm light, the buzzer and the wireless transmission unit operate. As a result, when the locking device is not locked, the user is informed as such through the lights, sounds and signals sent from the magnetic induction unit so that the user can react immediately to protect his/her indoor security.

### BRIEF DESCRIPTION OF THE DRAWINGS

Other features and advantages of this invention will become more apparent in the following detailed description of the preferred embodiments of this invention, with reference to the accompanying drawings.

FIG. 1 is a drawing showing a conventional magnetic induction alarm device.

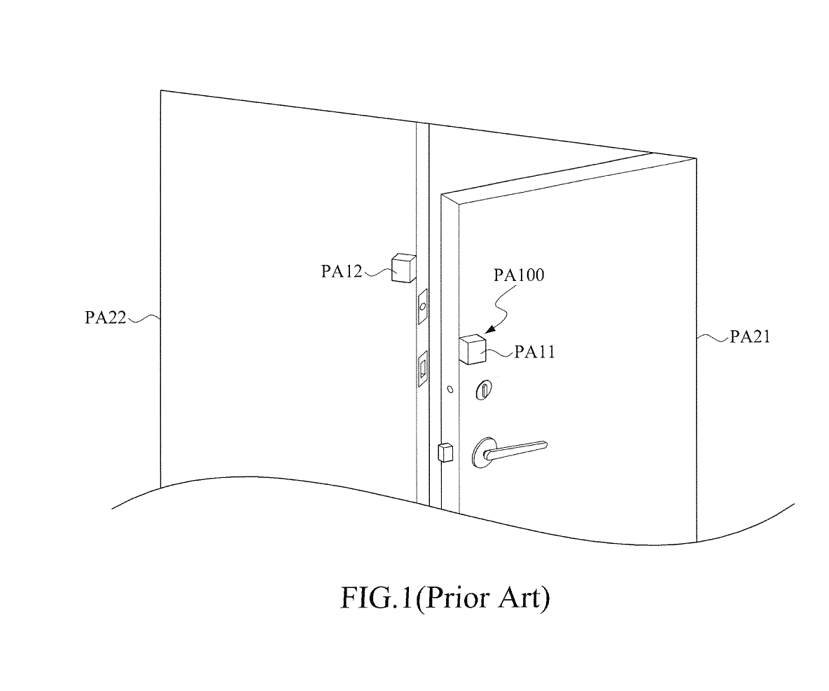

FIG. 2 is a schematic view of a magnetic induction alarm device according to an embodiment of the present invention.

FIG. 3 is a partially enlarged schematic view a magnetic induction alarm device according to an embodiment of the present invention.

FIG. 4 is a partially enlarged schematic view a magnetic induction alarm device according to an embodiment of the present invention.

FIG. 5 is a block diagram showing a magnetic induction alarm device according to an embodiment of the present invention.

FIG. 6 is a schematic view of a magnetic induction alarm device according to the first embodiment of the present invention.

FIG. 7 is a schematic view of a magnetic induction alarm device according to the second embodiment of the present invention.

FIG. 8 is another schematic view of the magnetic induction alarm device according to the second embodiment of the present invention.

### DETAILED DESCRIPTION OF THE PREFERRED EMBODIMENT

The present invention relates to a magnetic induction alarm device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

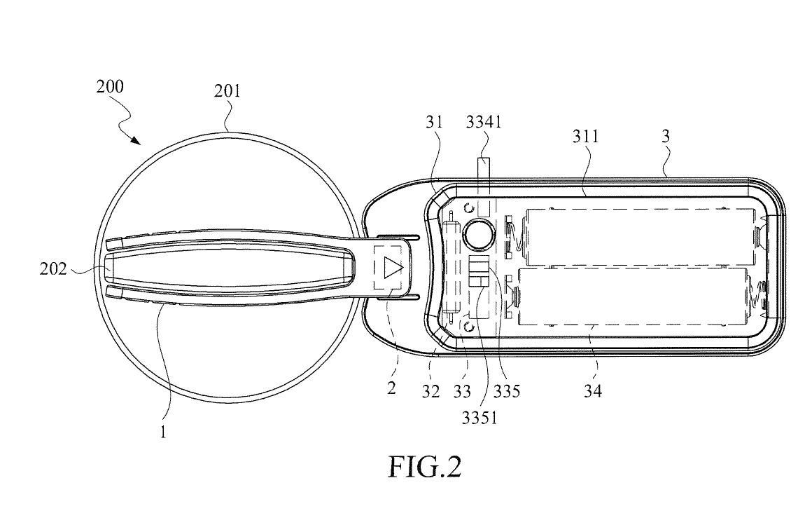

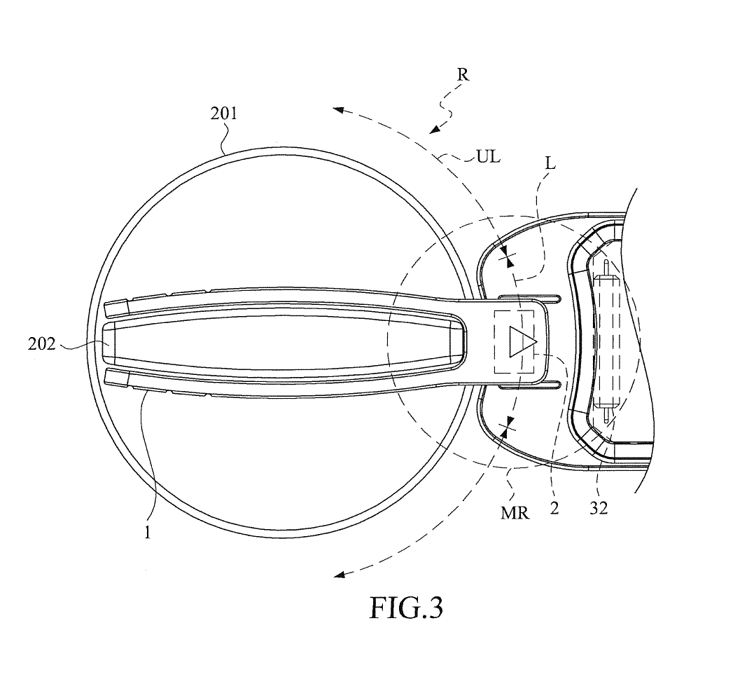

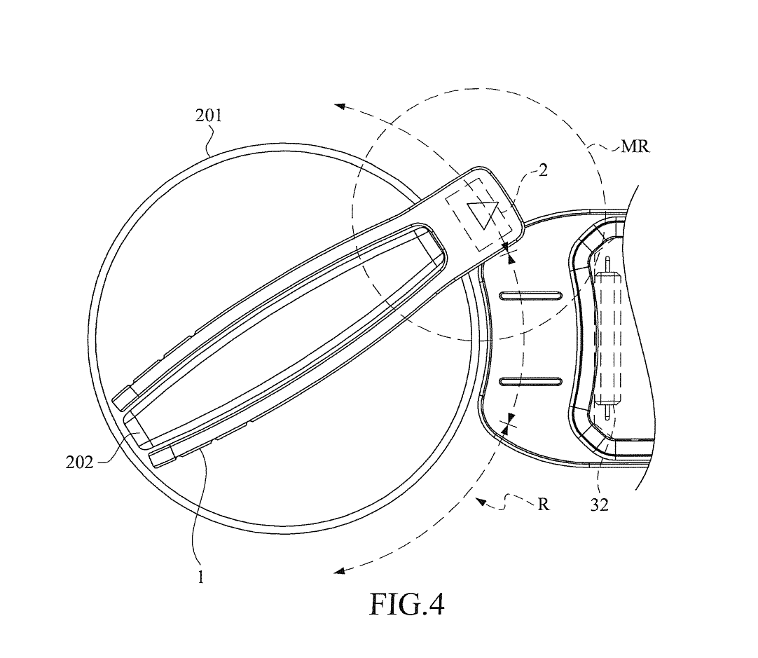

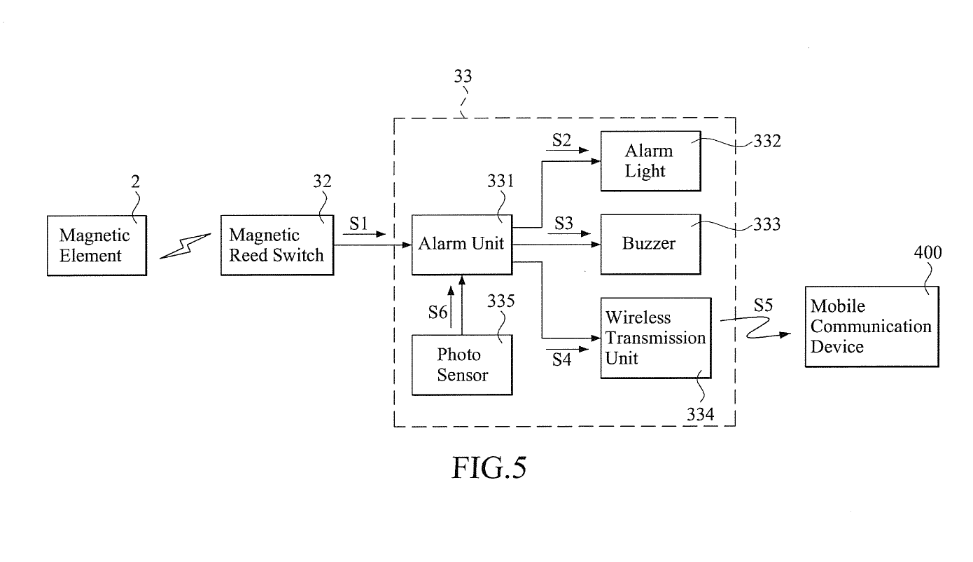

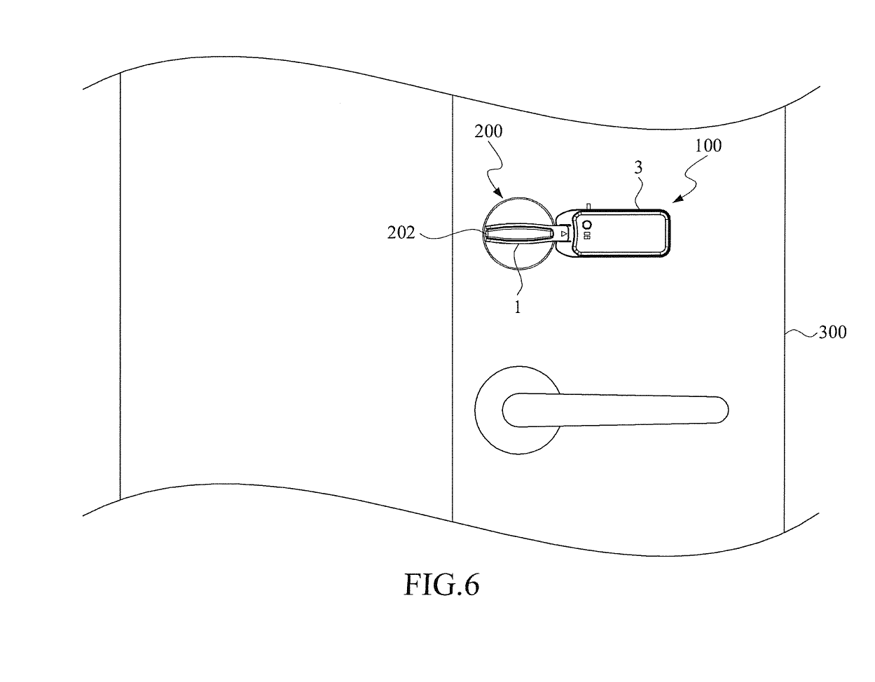

Refer to FIGS. 2, 3, 4, 5 and 6. FIG. 2 is a schematic view of a magnetic induction alarm device according to an embodiment of the present invention; FIG. 3 is a partially enlarged schematic view a magnetic induction alarm device according to an embodiment of the present invention; FIG. 4 is another partially enlarged schematic view a magnetic induction alarm device according to an embodiment of the present invention; FIG. 5 is a block diagram showing a magnetic induction alarm device according to an embodiment of the present invention; FIG. 6 is a schematic view of a magnetic induction alarm device according to the first embodiment of the present invention.

A magnetic induction alarm device 100 for a locking device 200 is provided according to embodiments of the present invention. The locking device 200 includes a base 201 and a latch knob 202; the latch knob 202 is disposed on the base 201 movably along a route R; the route R includes a lock section L and an unlock section UL next to the lock section L.

The magnetic induction alarm device 100 includes a fixing member 1, a magnetic element 2 and a magnetic induction unit 3. The magnetic element 2 is disposed inside the fixing member 1 and is fixed on an end of the latch knob 202 via the fixing member 1; the magnetic element 2 has a magnetic region MR moving accordingly when the latch knob 202 is rotated, carrying the magnetic element 2 along the route R. The magnetic induction unit 3 includes a shell 31, a magnetic reed switch 32, an alarm module 33 and two batteries 34 (only one is numbered in the figures).

The shell 31 includes a holding space 311. The magnetic reed switch 32 is disposed next to the lock section L and is inside the holding space 311, wherein the magnetic region MR covers the magnetic reed switch 32 when the magnetic element 2 is located within the lock section L.

The alarm module 33 is disposed inside the holding space 311 and electrically connects the magnetic reed switch 32. The alarm module 33 includes an alarm unit 311, an alarm light 332, a buzzer 333, a wireless transmission unit 334 and a photo sensor 335.

The alarm unit 311 electrically connects the magnetic reed switch 32 for receiving an alarm signal S1 sent from the magnetic reed switch 32. The alarm light 332 receives an alarm light signal S2 sent from the alarm unit 331 and sends a flashlight. The buzzer 333 receives an alarm sound signal S3 sent from the alarm unit 331 and sends an alarm sounds. The wireless transmission unit 332 receives a signal S4 sent from the alarm unit 331 to generates a wireless transmission signal S5. The wireless transmission signal S5 is transmitted to a mobile communication device 400 via an antenna 3341. The wireless transmission unit 334 is selected from the group of wireless radio frequency transmission unit, Bluetooth transmission unit, Wi-Fi transmission unit, and WiMAX transmission unit. The photo sensor 335 electrically connects the alarm unit 331, the photo sensor generating a photo sensing signal S6 to the alarm unit 331 according to the intensity of an ambient light illumination, wherein the photo sensor 335 includes a switch 3351 electrically connecting the photo sensor 335 so the photo sensor 335 switches to an automatic photo sensing mode or a manual photo sensing mode. The batteries 34 provide power for operating the magnetic reed switch 32 and the alarm module 33 of the magnetic induction unit 3.

The locking device 200 is disposed on the inside of a door 300 and is utilized as a second lock. When the user enters the room and locks up the locking device 200, the magnetic element 2 of the magnetic induction alarm device 100 is fixed on the latch knob 202 via the fixing member 1 and is moved from the unlock section UL to the lock section L along the rotation of the latch knob 202. When the magnetic region MR covers the nearby magnetic reed switch 32 of the magnetic induction unit 3, the status of a circuit is changed from ON: two magnetic reeds (not shown) attracting each other to OFF: the two magnetic reeds repelling each other.

In other words, if the user does not lock up the locking device 200, the magnetic element 2 stays in the unlock section UL so the magnetic reed switch 32 is outside the coverage of the magnetic region MR—the two magnetic reeds inside the magnetic reed switch 32 changes the status of the circuit from OFF: the two magnetic reeds repelling each other to ON: the two magnetic reeds attracting each other; further, the alarm signal S1 is generated and sent to the alarm unit 331, triggering the alarm unit 331 to generate the alarm light signal S2, the alarm sound signal S3, and the signal S4. The alarm light signal S2 is transmitted to the alarm light 332; the alarm sound signal S3 is transmitted to the buzzer 333; the signal S4 is transmitted to the wireless transmission unit 334. The alarm light 332 flashes to remind the user and the buzzer 333 buzzes to further remind the user that the locking device 200 is not locked up. The wireless transmission unit 334 transmits the wireless transmission signal S5 to the mobile communication device 400 carried by the user at the same time. Therefore, if the user is farther away from the magnetic induction alarm device 100 and fails to notice the flashlights of the alarm light 332 and the noises of the buzzer 333, he/she can still receives the wireless transmission signal S5 on his/her mobile communication device 400 and be informed that the locking device 200 is not locked up. According to other embodiments of the present invention, when people outside the door try to unlock the locking device, the magnetic element will move from the lock section to the unlock section according to the rotation of the latch knob and further trigger the magnetic induction alarm device to send flashlights, sounds and communication signals. Thus, the user can be informed immediately when the locking device has not yet unlocked completely.

The user can switch between the automatic photo sensing mode and the manual photo sensing mode via the switch 3351 of the magnetic induction unit 3. The manual photo sensing mode includes an ON mode and an OFF mode, so the user can switch among automatic photo sensing mode, the ON mode and the OFF mode. When the user switches to the automatic photo sensing mode, the photo sensor 335 senses the intensity of the ambient light illumination. The intensity of the ambient light illumination corresponds to daytime, all lights in the room being turned on, nighttime, or all lights in the room being turned off. When the photo sensor 335 senses a strong intensity of the ambient light illumination (i.e. daytime or all lights in the room being turned on), it generates and sends a photo sensing signal S6 to the alarm unit 331. Therefore, when the alarm unit 331 receives the alarm signal S1, it will not generate and send the alarm light signal S2, the alarm sound signal S3 nor the signal S4. When the photo sensor 335 senses a weak intensity of the ambient light illumination (i.e. nighttime or all lights in the room being turned off) and when the locking device 200 is not locked up, the magnetic induction alarm device 100 motivates the alarm unit 331 to send alarm light signal S2, alarm sound signal S3 and signal S4 after receiving the alarm signal S1. Therefore, the magnetic induction alarm device 100 sends flashlights, sounds and communication signals to remind the user that the locking device 200 is not locked up. When the user switches it to the ON mode, after the alarm unit 331 of the alarm module 33 receives the alarm signal S1, it directly generates and send the alarm light signal S2, the alarm sound signal S3 and the signal S4; when the user switches it to the OFF mode, the alarm module 33 will not be operating.

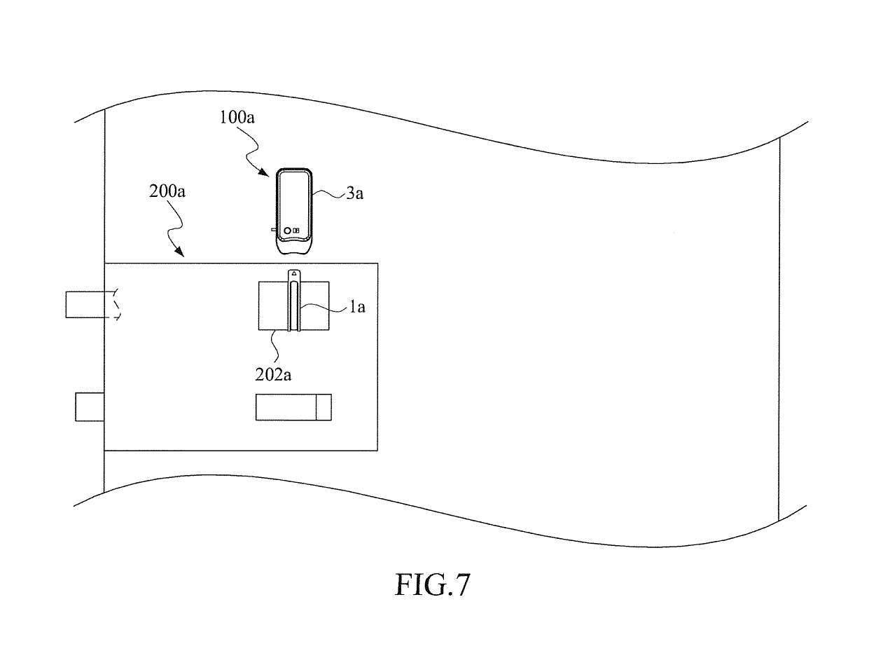

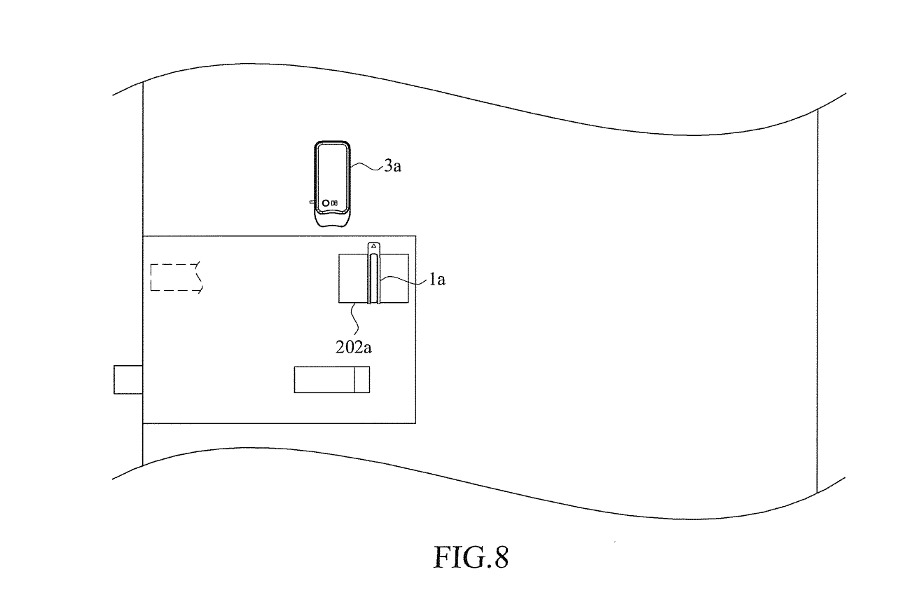

Refer to FIG. 7 and FIG. 8. FIG. 7 is a schematic view of a magnetic induction alarm device according to the second embodiment of the present invention; FIG. 8 is another schematic view of the magnetic induction alarm device according to the second embodiment of the present invention. The difference between the magnetic induction alarm device 100a of the second embodiment and the magnetic induction alarm device 100 of the first embodiment is that according to the second embodiment of the present invention, a fixing member 1a of the magnetic induction alarm device 100a is disposed on a protruding latch knob 202a installed on a traditional Chinese styled locking device 200a. The fixing member la includes materials of flexibility and therefore the fixing member la can be transformed according to the shape of the latch knob 202a and become similar to the shape to be fixed on the latch knob 202a. According to other embodiments of the present invention, the magnetic induction alarm device can be utilized for locking devices on windows or closets and the fixing member can be transformed according to different latch knobs. The latch 202a moves horizontally on the locking device 200a. When the user does not lock up the locking device 200a, the fixing member la stays in the unlock section (not shown) and since the magnetic reed switch (not shown) stays away from the coverage of the magnetic region, all units in the magnetic induction unit 3a are triggered to send flashlights, sounds and communication signals so the user knows immediately whether the locking device 200a is locked up and further protects the indoor security.

It is necessary to emphasized that the concept of abovementioned “alarm” is a means to remind or warn the user or anybody concerned that “do not forget to lock the locking device when it shall be locked”. Therefore, abovementioned “magnetic induction alarm device” can be viewed as a device provided for the user or anybody concerned, so as to remind or warn him not forget to lock the locking device when it shall be locked. Undoubtedly, in practical, when the “magnetic induction alarm device” is applied to the locking device of deadbolt lock, it also can be viewed as a “deadbolt lock reminder”.

In conclusion, the magnetic induction alarm device provided according to embodiments of the present invention includes a fixing member, a magnetic element and a magnetic induction unit.

The magnetic element is fixed on the latch knob via the fixing member; the magnetic element includes a magnetic region. When the latch knob rotates and brings the magnetic element to the unlock section along a route, a magnetic reed switch of the magnetic induction alarm device is located outside the coverage of the magnetic region and thus triggers an alarm light, a buzzer and a wireless transmission unit inside the magnetic induction unit to operate. Therefore, when the locking device is not locked up, the user can be informed and react to increase the indoor security. A photo sensor of the magnetic induction unit allows the user to further switch the magnetic induction alarm device to automatically operates according to various light intensity.

While the present invention has been particularly shown and described with reference to a preferred embodiment, it will be understood by those skilled in the art that various changes in form and detail may be without departing from the spirit and scope of the present invention.

What is claimed is:

1. A magnetic induction alarm device for a locking device, the locking device including a base and a latch knob disposed on the base movably along a route, the route including a lock section and an unlock section next to the lock section, the magnetic induction alarm device comprising:
a magnetic element linking up with an end of the latch knob and having a magnetic region; and
a magnetic induction unit next to the locking device, the magnetic induction unit including:
a shell having a holding space;
a magnetic reed switch disposed next to the lock section and inside the holding space, wherein the magnetic region covers the magnetic reed switch when the magnetic element is located within the lock section; and
an alarm module disposed inside the holding space and electrically connecting the magnetic reed switch.

2. The magnetic induction alarm device according to claim 1, further comprising a fixing member disposed on the latch knob, wherein the magnetic element is disposed on the fixing member so the magnetic element is disposed on the latch knob via the fixing member.

3. The magnetic induction alarm device according to claim 1, wherein the alarm module includes an alarm unit electrically connecting the magnetic reed switch.

4. The magnetic induction alarm device according to claim 3, wherein the alarm module further includes an alarm light electrically connecting the alarm unit.

5. The magnetic induction alarm device according to claim 3, wherein the alarm module further includes a buzzer electrically connecting the alarm unit.

6. The magnetic induction alarm device according to claim 3, wherein the alarm module further includes a wireless transmission unit electrically connecting the alarm unit.

7. The magnetic induction alarm device according to claim 6, wherein the wireless transmission unit is selected from the group of wireless radio frequency transmission unit, Bluetooth transmission unit, Wi-Fi transmission unit, and WiMAX transmission unit.

8. The magnetic induction alarm device according to claim 3, wherein the alarm module further includes a photo sensor electrically connecting the alarm unit.

9. The magnetic induction alarm device according to claim 8, wherein the photo sensor includes a switch electrically connecting the photo sensor.
